(19) United States
(12) Patent Application Publication
(10) Pub. No.: US 2007/0156640 A1
(43) Pub. Date: Jul. 5, 2007

(54) Hot tuple detection

(75) Inventor: Vibhuti Singh Sengar, Unnao (IN)

Correspondence Address: IBM ALMADEN (AVE);c/o LAW OFFICE OF ANTHONY ENGLAND, P.O. BOX 5307, AUSTIN, TX, 78763, US

(73) Assignee: International Business Machines Corporation

(21) Appl. No.: 11/321,662

(22) Filed: Dec. 29, 2005

(51) Int. Cl. G06F 17/30

(52) U.S. Cl. 707/2

(57) ABSTRACT

Hot tuples within a database are detected. The hot tuples are within a selected table having a number of columns over which tuples are stored. The hot tuples are thus included within the tuples stored in the selected table, and are defined as the tuples that are frequently referenced by tuples of one or more other tables. Such hot tuples may be detected without regards to select conditions placed on them via queries of query templates. Detection of the hot tuples is based on the query templates of such queries that are processed against the database, which includes the selected table and the other tables referencing the selected table. The database is stored on a non-volatile storage. The hot tuples detected are stored or placed to provide for quicker access thereof.

### FIELD OF THE INVENTION

The present invention relates generally to databases having tables in which tuples are stored, and more particularly to detecting such tuples that are “hot,” which are the tuples within a selected table of the database that are frequently accessed.

### BACKGROUND OF THE INVENTION

A database is a set of related files that is created and managed by a database management system (DBMS). DBMS's can manage any form of data including text, images, sound and video. Data stored within a database may be organized in tables, where each table includes a number of columns representing data fields, and a number of rows that represent individual records having data in accordance with the data fields. A relational database allows the various columns and rows of the tables to be interrelated, so that one table can refer to another table, for instance.

For example, there may be two tables within a database. The first table may be an employee table, which has columns corresponding to an employee identifier, the name of the employee, the salary of the employee, and a department identifier of the employee.

Each row, or record, of this table thus has data specifying a particular employee's employee identifier, name, salary, and department identifier. The second table may be a department table, which has columns specifying a department identifier, the name of the department, and the location of the department. Each row, or record, of this table thus has data specifying a particular department's department identifier, name, and location.

The first and the second tables in this example can be merged, or joined, to yield all the employees within particular departments. For example, for a second table record corresponding to a desired department, the department identifier is acquired. This department identifier is then compared to the department identifiers stored in the first table record. The result is the identification of all the employees that belong to the desired department. The joining process is more generally the matching of one table against another table, particularly based on some conditions in some situations.

An example of a join operation is as follows. First, the term join refers to join conditions given in the where clauses of database queries. For example, an query may be “select Retention, E.Name, D.Location from Employee D, Dept D, where E.salary=80,000 and E.DKey=D.DKey.” In this example, “E.DKey=D.DKey” is the join condition. By comparison, the other condition, “E.salary=80,000” is a select condition.

The data stored in the tables of a database can be referred to as tuples. A tuple may be considered a data object that holds several objects in an ordered manner, and which corresponds to a record, or row, of a table. For instance, if a given table defines a number of columns (A, B, C) then a given tuple X is equal to (X_{A}, X_{B}, X_{C}), where X_{A} is the data of this tuple within the column A, X_{B} is the data of this tuple within the column B, and X_{C} is the data of this tuple within the column C.

A database is typically stored on a non-volatile storage device, such as one or more hard disk drives. Such storage is advantageous because these types of storage devices can typically store large amounts of data at relatively low cost. Furthermore, should power be removed from these storage devices, the data stored on them is not lost. However, a disadvantage to non-volatile storage devices is that they are relatively slow, as compared to, for instance, volatile storage devices, such as semiconductor memories like dynamic random-access memory (DRAM). This means that returning matched data in response to queries, which are interrogations of the database for desired data, can be quite slow.

A common solution is to buffer or cache the most frequently accessed data stored within database within a more quickly accessed storage device, such as a DRAM. The idea is that this type of storage of the most frequently accessed data will improve the performance of query processing, since such data is accessed more often than other data of the database. Because DRAM and other such volatile storage devices are typically more costly than non-volatile storage devices like hard disk drives, only a portion of the data of a database can be buffered or cached within such volatile storage devices.

In the case of a database, buffering or caching the most frequently accessed data stored within the database means that the most frequently accessed tuples of the database are buffered or cached. Therefore, in the first instance, these most frequently accessed tuples, which are referred to as “hot” tuples herein, have to be detected, or discovered. However, discovery of hot tuples within databases is not a trivial problem, which means that in prior art databases, input/output (I/O) performance can suffer due to the hot tuples not being correctly buffered or cached.

Hot tuples can be classified in two ways. First, tuples of a database become hotter due to the access of their table through execution of skewed bind variable distribution in select conditions (e.g., that the salary field is greater than $80,000) within queries. That is, a bind variable is a variable specified within a select condition, such as “E.salary=80,000” in the example noted above. Therefore, select conditions denote which data of the database are to be returned in response to a query, by specifying conditions on the actual data of the records, or tuples, stored over the columns of a table of the database. For example, with respect to the example noted above, in the employee table, a select condition may be the specification of all employees who have salaries over $80,000. Not all the tuples, or records, within the table will likely satisfy this select condition.

Tracking hot tuples that become hotter due to the access of their table through execution of such select conditions within queries is difficult, however. It requires logging all the queries processed against a database, which results in a large amount of overhead. As a result, tracking this type of hot tuples is disadvantageous, because the overhead required to detect them may be outweighed by the overhead required.

Second, tuples of a database become hotter because of skewed access of their table through execution of join condition, or merge, operations involving their table. Skew in this sense means that tuples of some tables will reference many more of the tuples of another table than other tuples of the same or other tables do. For instance, in the example described above, it is likely that some departments represented by tuples within the department table match many more employees represented by tuples within the employee table than other departments represented by other tuples within the department table do. For example, within a given organization, there may be relatively few executives, and a relatively large number of factory workers. As a result, the tuple representing factory workers within the department table matches many more employees represented by tuples within the employee table than the tuple representing executives within the department table does.

Such skew results from the “many-to-one” relationship between the employee table and the department table. That is, for a given department represented by a tuple within the department table, there can be many tuples within the employee table referencing the same department. The joining or merging of these two tables is thus said to be skewed, because it is asymmetrical, and is biased towards those tuples of the department table representing departments for which there are larger number of employees represented by tuples within the employee table.

As a result of such skew, the merging or joining of the employee table and the department table results in more frequent access of tuples within the department table that correspond to departments having larger number of employees. More generally, a merging or joining operation between a first table and a second table in which there is a skewed many-to-one relationship results in a skewed access pattern of the tuples in the second table. The tuples of the second table towards which the tuples of the first table are skewed are thus the hot tuples.

Therefore, it can be desirable to detect or discover such hot tuples, and temporarily cache them or place them efficiently using known hot object placement techniques, so that their access within the database does not require constantly retrieving the tuples in question from a non-volatile storage device like a hard disk drive, but rather just requires their retrieval from a faster volatile storage device like a DRAM. For instance, in the example that has been described, tuples within the department table that represent departments for which there are larger number of employees represented by the tuples within the employee table are hot tuples that should be detected and buffered or cached. However, the prior art does not provide for mechanisms to detect or discover such hot tuples.

### SUMMARY OF THE INVENTION

The present invention detects hot tuples within a database. A method of an embodiment of the invention detects such hot tuples within a selected table having a number of columns over which tuples are stored. The hot tuples are included within the tuples stored in the selected table, and are defined as the tuples that are frequently referenced by tuples of one or more other tables. In one embodiment, such hot tuples are detected without regards to bind variables of the select conditions placed on them via queries of query templates. Detection of the hot tuples is based on the query templates of such queries that are processed against the database, which includes the selected table and the other tables referencing the selected table. The database is stored on a non-volatile storage. The method also includes storing or placing the hot tuples detected to provide for quicker access thereof.

A computerized system of an embodiment of the invention includes a non-volatile storage, a storage that is more quickly accessed than the non-volatile storage is, and a mechanism. The non-volatile storage stores a database including a selected table having a number of columns over which tuples are stored, and one or more other tables referencing the selected table. The storage that is more quickly accessed stores hot tuples within the selected table, which are the tuples of the selected table that are frequently referenced by tuples of the other tables. The discovered hot tuples can also be placed efficiently using known hot object placement techniques. The mechanism detects the hot tuples within the selected table, based on query templates of queries processed against the database, and stores them within the storage that is more quickly accessed. In one embodiment, the hot tuples are detected without regards to bind variables in the select conditions placed on them via the queries of the query templates.

An article of manufacture of an embodiment of the invention includes a tangible recordable data storage medium, and means in the medium. The means may be a computer program, for instance, and is for detecting hot tuples within a selected table having a number of columns over which tuples are stored, based on query templates of queries processed against a database. The database includes the selected table and one or more other tables referencing the selected table. The means is further for storing the hot tuples within a storage that is more quickly accessed than a non-volatile storage storing the database. The hot tuples are included within the tuples stored in the selected table and are those tuples that are frequently referenced by tuples of the other tables. The hot tuples are detected without regards to bind variables in the select conditions placed on them via the queries of the query templates.

Embodiments of the invention provide for advantages over the prior art. In particular, the invention provides for the detection of hot tuples within a selected table of a database. The invention particularly is used for detecting as hot tuples those tuples of the selected table that are frequently referenced by tuples of other tables of the database, based on queries of query templates. In one embodiment, the invention is particularly used for detection of such hot tuples without regards to bind variables in the select conditions placed on them via the queries of the query templates, so that significant overhead is not required in detecting the hot tuples. The invention stores the hot tuples within a storage that is more quickly accessed than a storage device that wholly stores the database is accessed. However the discovered hot tuples can be placed on any appropriate media (e.g., hard disk, main memory, and so on) using already existing hot object placement techniques. By such hot tuple storage, input/output (I/O) performance of the database is improved.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example database, in conjunction with which embodiments of the invention may be performed or implemented, and in relation to which embodiments of the invention are described.

FIG. 2 is a diagram of a computerized system, according to an embodiment of the invention.

FIG. 3 is a flowchart of a method, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

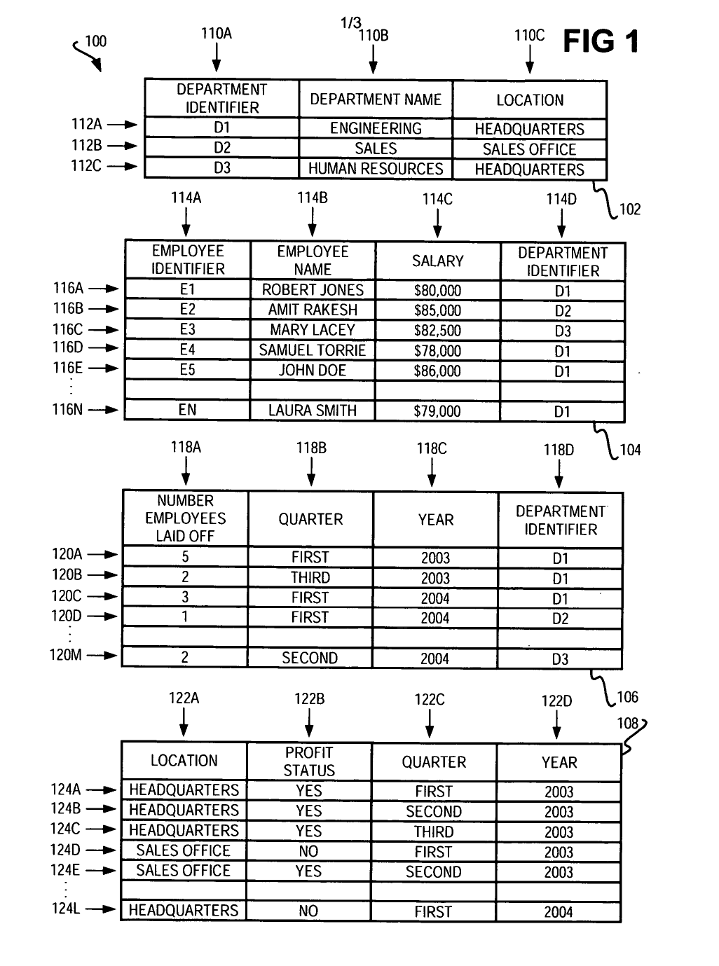

FIG. 1 shows an example database 100, in accordance with which embodiments of the invention are described. The database 100 includes four tables 102, 104, 106, and 108. The table 102 is a department table, and has columns 110A, 110B, and 110C, collectively referred to as the columns 110, specifying a department identifier, a department name, and a location, respectively. These are the table fields of the table 102. The table 102 also includes three records, rows, or tuples 112A, 112B, and 112C, collectively referred to as the tuples 112, and which store the data of the table 102 over the columns 110. That is, each of the tuples 112 has data for each of the table fields of the columns 110 of the table 102. For example, the department specified by the tuple 112A has a department identifier of D1, a department name of engineering, and a location of headquarters.

The table 104 is an employee table, and has columns 114A, 114B, 114C, and 114D, collectively referred to as the columns 114, specifying an employee identifier, an employee name, a salary, and a department identifier, respectively. These are the table fields of the table 104. The table 104 also includes a number of records, rows, or tuples 116A, 116B, 116C, 116D, 116E, . . . , 116N, collectively referred to as the tuples 116, and which store the data of the table 104 over the columns 114. That is, each of the tuples 116 has data for each of the table fields of the columns 114 of the table 102. For example, the employee specified by the tuple 116A has an employee identifier of E1, an employee name of Robert Jones, a salary of $80,000, and a department identifier of D1.

The table 106 is an employees-laid-off table, and has columns 118A, 118B, 118C, and 118D, collectively referred to as the columns 118, specifying a number of employees laid off, in a given quarter, of a given year, for a given department identified by a department identifier. These are the table fields of the table 106. The table 106 also includes a number of records, rows, or tuples 120A, 120B, 120C, 120D, . . . , 120M, collectively referred to as the tuples 120, and which store the data of the table 106 over the columns 118. That is, each of the tuples 120 has data for each of the table fields of the columns 118 of the table 106. For example, the laid-off data specified by the tuple 120A indicates that five employees were laid off in the first quarter of 2003, from the department identified by the department identifier D1.

The table 108 is a profit-status table, and has columns 122A, 122B, 122C, and 122D, collectively referred to as the columns 122, specifying a location for which a profit status is reported, in a given quarter of a given year. These are the table fields of the table 108. The table 108 also includes a number of records, rows, or tuples 124A, 124B, 124C, 124D, 124E, . . . , 124L, collectively referred to as the tuples 124, and which store the data of the table 108 over the columns 122. That is, each of the tuples 124 has data for each of the table fields of the columns 122 of the table 108. For example, the profit-status data specified by the tuple 124A indicates that at headquarters, a profit was recorded in the first quarter of 2003.

Because of commonality between the table 102 and the tables 104, 106, and 108, the table 102 is capable of being merged, or joined, with the tables 104, 106, and 108. For example, the table 104 includes the column 114D that specifies a department identifier, and thus references the column 110A of the table 102, which also specifies a department identifier. Similarly, the table 106 includes the column 118D that specifies a department identifier, and thus also references the column 110A of the table 102. The table 108 includes the column 122A that specifies a location, and thus references the column 110C of the table 102, which also specifies a location.

A query can specify that records from two or more tables that are joined, or merged, and that satisfy a selected criteria, be returned. A query template represents one or more such queries that join the same two or more tables, but is independent of the different criteria (i.e., bind variables) used by its queries to interrogate the database 100. The query template is a query where values (e.g., such as $80,000) in the select conditions of the where clause are replaced by placeholders called and referred to as bind variables. For example, a first query may specify that the tables 102 and 104 be joined, and that the resulting records be searched for employees having salaries over $85,000. The result of such a query would be a single record representing the joining of the tuple 116E of the table 104 with the tuple 112A of the table 102: an employee named John Doe, having an employee identifier E5, making $86,000, and who is in a department identified by the department identifier D1, which is engineering, located in headquarters. That is, the information of the tuple 116E can be merged or joined with the tuple 112A because they share a common value, D1, for a common column, the column 114D of the table 104 specifying a department identifier, which is the same as the column 110A of the table 102, also specifying a department identifier.

Stated another way, a query template is a query where values (e.g., such as $80,000) within select conditions of where clauses of the query are replaced by placeholders referred to and known as bind variables. For example, consider the following query: “select Retention, E.Name, D.Location from Employee D, Dept D where E.salary=1 and E.DKey=D.DKey”. In this example, the “1” for E.salary is a bind variable, and therefore is replaced by a placeholder, such as n. Thus, embodiments of the invention are novel at least because they do not require that the distribution of bind variables be known for a given query template.

As another example, a second query may also specify that the tables 102 and 104 be joined, and that the resulting records be searched for employees having salaries under $79,000. The result of such a query would be a single record representing the joining of the tuple 116D of the table 106 with the tuple 112A of the table 102: an employee named Samuel Torrie, having an employee identifier E4, making $78,000, and is in a department identified by the department identifier D1, which is engineering, located in headquarters. That is, the information of the tuple 116D can be merged or joined with the tuple 112A because they share a common value, D1, for a common column, the column 114D of the table 104 specifying a department identifier, which is the same as the column 110A of the table 102, also specifying a department identifier.

With respect to these two example queries, they are different insofar as they have different select conditions for returning records. The first query, for instance, specifies employees having salaries over $85,000, whereas the second query specifies employees having salaries under $78,000. However, both of these queries merge or join the same two tables 102 and 104. Therefore, it can be said that these queries are of the same query template. This is because a query template is independent of the specific select conditions that a given query may place on the data within the tables, but rather just defines which tables are joined or merged. It is noted, however, that often the select conditions are first processed, or executed, and then the joining of the tables is performed, rather than vice-versa as may be implied above. Thus, any query that initially merges or joins the table 102 and the table 104 is encompassed by the same query template.

Embodiments of the invention determine hot tuples by detecting frequently referenced tuples of a selected table by the tuples of one or more other tables. Because in some embodiments the detection of hot tuples is not particularly concerned with the select conditions placed on the data of the tuples by specific queries, the queries themselves do not have to be concentrated upon, but only the query templates of these queries themselves.

Detection of hot tuples is particularly described in relation to such detection of the table 102 of the database 100, as the selected table in question. First, consider the situation where the database 100 is considered to have just two tables: the table 102 and the table 104, and what is desired to detect hot tuples in the table 102, and the table 102 is present in only one query template; the query template that specifies the merging of the tables 102 and 104. In this example, then, a single other table, the table 104, references the selected table, the table 102. More particularly, the tuples 116 of the table 104, via their data within the column 114D reference the tuples 112 of the table 102, and specifically their data within the column 110A.

Therefore, detecting the hot tuples in this situation includes detecting frequently occurring values within the table 104 as to the table 102. In particular, the tuples 116 of the table 104 have data in the department identifier column 114D as D1, D2, or D3. More specifically, four of the tuples 116 have the value D1 in the column 114D, one of the tuples 116 has the value D2, and one has the value D3. Therefore, it can be said that the tuple 112A of the table 102 is referenced four times within the table 104, because the tuple 112A has a department identifier of D1 in the column 110, and this same department identifier of D1 is found in four of the tuples 116 of the table 104. Similarly, it can be said that the tuple 112B of the table 102 is referenced once within the table 104, and that the tuple 112C is referenced once within the table 104.

As a result, the hottest tuple of the table 102 the in this situation is the tuple 112A. This is because when the tables 102 and 104 are joined, the tuple 112A is accessed four times to create the resultingly joined records: once for merging with the tuple 116A of the table 104, once for merging with the tuple 116D, once for merging with the tuple 116E, and once for merging with the tuple 116N. Thus, the most frequently occurring value within the table 104, in relation to the table 102, is the department identifier value of D1.

In the situation just described, all of the tuples 116 within the table 104 may be considered in relation to the table 102, since there are so few of the tuples 116 within the table 104. However, more generally, only a selection of the tuples 116 within the table 104 may be examined to determine the hot tuples within the table 102, to improve performance. For instance, in one embodiment, a random-sampling technique or approach, such as a sequential random-sampling technique or approach, can be employed to select which of the tuples in a single other table that references a selected table are to be considered for determining the hot tuples of the selected table. Such a technique or approach is described, for instance, in J. S. Vitter, “An efficient algorithm for sequential random sampling,” ACM Transactions on Mathematical Software, March 1987, 58-67.

Next, consider the situation where the database 100 is considered to have three tables, the tables 102, 104, and 106, and what is desired is to detect hot tuples in the table 102, and the table 102 is present in two query templates, a first query template that specifies the merging of the tables 102 and 104, and a second query template that specifies the merging of the tables 102 and 106. That is, the term merging as used herein refers to a join operation performed for evaluation of a join condition specified in a where clause of a query, as can be appreciated by those of ordinary skill within the art. In this example, then, two other tables, the tables 104 and 106, each reference the selected table, the table 102. More particularly, the tuples 116 of the table 104, and the tuples 120 of the table 106, all reference the same selected column 110A of the selected table 102. This is because the commonality between the table 104 and the table 102 is the department identifier column 114D of the table 104 being the same as the department identifier column 110A of the table 102, and likewise the commonality between the tables 106 and 102 is the department identifier column 118D being the same as the column 110A.

Therefore, detecting the hot tuples in this situation includes at least two things. First, the frequently occurring values within a joining column of each of the other tables 104 and 106 that reference the same selected column 110A of the selected table 102 are determined. With respect to the table 104, as has been noted above, the tuples 116A, 116D, 116E, and 116N all have the same department identifier D1, and therefore all reference the tuple 112A of the table 102. Similarly, the tuple 116B of the table 104 has the department identifier D2, and thus references the tuple 112B of the table 102, which has the same department identifier. The tuple 116C of the table 104 has the department identifier D3, and thus references the tuple 112C of the table 102, which has the same department identifier. Therefore, it can be said that the tuple 112A of the table 102 is referenced four times within the table 104, and the tuples 112B and 112C are each referenced one time within the table 104.

With respect to the table 106, the tuples 120A, 120B, and 120C all reference the tuple 112A of the table 102, because they have the same department identifier D1 as the tuple 112A. The tuple 120D of the table 106 references the tuple 112B of the table 102, because the tuples 120D and 112B both have the same department identifier D2. The tuple 120M of the table 106 references the tuple 112C of the table 102, because the tuples 120M and 112C both have the same identifier D3. Therefore, it can be said that the tuple 112A of the table 102 is referenced three times within the table 106, and the tuples 112B and 112C are each referenced one time within the table 106.

Second, corresponding of the frequently occurring values over the other tables 104 and 106 are joined to yield merged frequently occurring values. In one embodiment, this entails simply adding the number of times each of the tuples 112 within the selected table 102 are referenced by the table 104 with the number of times each of the tuples 112 are referenced by the table 106. Therefore, because the tuple 112A is referenced four times by the table 104 and three times by the table 106, the tuple 112A is in total referenced seven times. The tuple 112B is referenced once by each of the tables 104 and 106, yielding a total number of two times. The tuple 112C is also referenced once by each of the tables 104 and 106, yielding a total number of two times. Therefore, the hottest tuple in this situation is the tuple 112A, which is referenced a total of seven times by the tables 104 and 106.

In another embodiment, however, merging corresponding frequently occurring values among the tables 104 and 106 is accomplished by first weighting these values in accordance with the frequency of execution of the queries of the query templates in question. For example, as has been noted, a first query template may encompass queries in which the tables 104 and 102 are joined, and a second query template may encompass queries in which the tables 106 and 102 are joined. Queries of the first query template may represent 75% of the queries that are executed against the database 100, whereas queries of the second query template may represent 25% of the queries that are executed against the database.

Therefore, the number of times the tuple 112A of the table 102 is referenced by the table 104 may be multiplied by the former frequency of query execution, 75%, before being added to the number of times the tuple 112A of the table 102 is referenced by the table 104 as multiplied by the latter frequency of query execution, 25%. Thus, the resulting joined frequently occurring value for the tuple 112A is 75% times four, plus 25% times three, or 3.75. Likewise, the number of times the tuple 112B is referenced by the table 104 is multiplied by 75% before being added to the number of times the tuple 112B is referenced by the table 106 as multiplied by 25%. Similarly, the number of times the tuple 112C is referenced by the table 104 is multiplied by 75% before being added to the number of times the tuple 112C is referenced by the table 106 as multiplied by 25%. In either of these latter two instances, the resulting joined frequently occurring value is 75% times one, plus 25% time one, or one.

In the situation just described, all of the tuples 116 within the table 104 may be considered in relation to the table 102, and all the tuples 120 of the table 106 may also be considered in relation to the table 102. However, more generally, only a section of the tuples 116 and 120 within the tables 104 and 106, respectively, may be examined to determine the hot tuples within the table 102, to improve performance. As has been described, a random-sampling technique or approach, such as a sequential random-sampling technique or approach, may be employed to select which of the tuples of more than one other table that references a selected table are to be considered for determining the hot tuples of the selected table.

Finally, it is noted that there may be a situation where the database 100 is considered to have three tables, the tables 102, 104, and 108, for instance, and what is desired is to detect hot tuples in the table 102, and the table 102 is present in two query templates, a first template that specifies the merging of the tables 102 and 104, and a second template that specifies the merging of the tables 102 and 108. In this example, too, there are two other tables, the tables 104 and 108, which each reference the selected table, the table 102. However, the tuples 116 of the table 104 reference a different selected column of the selected table 102 than that which the tuples 124 of the table 108 reference. Particularly, the tuples 116 reference the department identifier column 110A of the table 102, since they include data for the same department identifier column 114D in the table 104. By comparison, the tuples 124 reference the location column 110C of the table 102, since they include data for the same location column 122A in the table 108. That is, there are more tables 104 and 108 which reference different selected columns of the selected table 102, the column 110A in the case of the table 104, and the column 110C in the case of the table 108.

The approach followed in this situation to detect the hot tuples is similar or identical to that which has been most recently described. That is, first, the frequently occurring values within a joining column of each of the multiple tables 104 and 108 that reference the same selected table 102 are determined. With respect to the table 104, as has been noted above, the tuples 116A, 116D, 116E, and 116N all have the same department identifier D1, and therefore all reference the tuple 112A of the table 102. Similarly, the tuple 116B of the table 104 has the department identifier D2, and thus references the tuple 112B of the table 102, which has the same department identifier. The tuple 116C of the table 104 has the department identifier D3, and thus references the tuple 112C of the table 102, which has the same department identifier. Therefore, it can be said that the tuple 112A of the table 102 is referenced four times within the table 104, and the tuples 112B and 112C are each referenced one time within the table 104.

With respect to the table 108, the tuples 124A, 124B, 124C, and 124L all reference the tuple 112A of the table 102, because they have the same location identifier “headquarters” as the tuple 112A. Furthermore, the tuples 124D and 124E of the table 108 reference the tuple 112B of the table 102, because the tuples 124D, 124E, and 112B all reference the same location identifier “sales office.” Therefore, it can be said that the tuple 112A of the table 102 is referenced four times within the table 108, the tuple 112B is referenced twice within the table 108, and the tuple 112C is not referenced at all within the table 108.

Second, as before, corresponding of the frequently occurring values over the multiple tables 104 and 108 are joined to yield frequently occurring values, with or without initial weighting of these values by the frequencies of execution of the queries of the query templates in question. For example, where such weighting is not used, the number of times the tuple 112A of the table 102 is referenced by each of the tables 104 and 108 is added, the number times the tuple 112B is referenced by each of the tables 104 and 108 is added, and the number of times the tuple 112C is referenced by each table is added. Therefore, the tuple 112A is referenced a total of nine times—five times by the table 104 and four times by the table 108. The tuple 112B is referenced a total of three times—once by the table 104 and twice by the table 108. The table 112C is referenced a total of one time, just by the table 104. Therefore, the hottest tuple in this situation is the tuple 112A, which is referenced a total of nine times by the tables 104 and 108.

In the situation just described, all of the tuples 116 within the table 104, and all of the tuples 124 within the table 108 may be considered in relation to the table 102. However, more generally, only a section of the tuples 116 and 124 within the tables 104 and 108, respectively, may be examined to determine the hot tuples within the table 102, to improve performance. A sequential random sampling cannot be employed in such a situation, in which multiple tables reference different selected columns of a selected table, as can be appreciated by those of ordinary skill within the art, to select which of the tuples of the multiple tables that reference a selected table are to be considered for determining the hot tuples of the selected table. However, as can also be appreciated by those of ordinary skill within the art, a variation of such sequential random sampling, or another type of random-sampling technique, may be employed to select which of the tuples of the multiple tables that reference a selected table are to be considered for determining the hot tuples of the selected table.

Two additional examples are provided for additional explanation. First, consider that the hot tuples within the table 102 are desired to be found, and that there are two query templates. The first query template is “select * from table 102, table 104 where table 104.salary is between 60,000 and 80,000 and table 104.DID=table 102.DID.” This query template is executed with a frequency of 25%. The second query template is “select * from table 102, table 106 where table 106.num_laidoff=4 and table 106.DID=table 102.DID.” This query template is executed with a frequency of 75%. Because the second query template is more frequent as compared to the first query template, the hot tuples detected via the second query template will be weighted more over the hot tuples detected via the first query template. However, on average, the select condition “T104.salary between 60,000 and 80,000” may select many tuples compared to the select condition “T106.num_laidoff=4.” Therefore, the hot tuples detected via the first query template receive priority.

In other words, the weighting as provided in embodiments of the invention can also consider the average number of tuples selected by a select condition of the referring table, along with the frequency of execution. If this average number of tuples is available, then the weighting factor equals the average number of tuples selected by the select condition of the referring table, times the number of queries executed that correspond to the query template. If this average number of tuples is not available, by comparison, then the weighting factor equals the number of queries that have been executed and that corresponding to the query template in question.

As a second, final example, consider a query on the tables Order, Customer, and District. For example, what may be desired is to determine the hot tuples in the Customer table due to the following query template: “select d.d_tax from Order O, Customer C, District D where O.o_amount equals 1,000 O.O_C_ID=C.C_ID and C.C_D_ID=D.D_ID.” Embodiments of the invention can analyze the distribution of data within the O_C_ID column of the Order table to detect the Customer table tuples that are being referred to by the tuples in the Order table. Furthermore, for each Customer table tuple, embodiments of the invention may count the number of Order table tuples that refer to a given customer tuple, and then select the customer tuples that are most frequently referred to by the Order table tuples. The most frequently referenced customer tuples are thus returned as Customer table hot tuples in relation to the above query template.

It is noted that the detection of hot tuples within the Customer table of the above example, due to query template execution, is based on the assumption that the Customer table will always join with the Order table. This assumption is most often true, but may not be true in some situations. In some cases, the Customer table may be joined with the District table, and then the output of this joining is joined with the Order table. Such information cannot be determined, however, by examining a query template itself. Therefore, embodiments of the invention can assume that the Customer table will always be able to be joined with the Order table.

Therefore, a pruning option can be provided, to handle the situation where the user is sure that the Customer table is not likely to be joined with the Order table, so that such cases can be removed from consideration by embodiments of the invention. That is, to determine the hot tuples within a select table, embodiments of the invention may first determine all query templates containing this selected table. Second, for each query template, based on the join conditions present in the query template, embodiments of the invention determine tables, which are known as referring tables, joining the selected table. However, in some situations the database engine may not join the determined table, or its intermediating output to the selected table. To handle these situations, then, the user may be provided an option to prune, or remove, such cases.

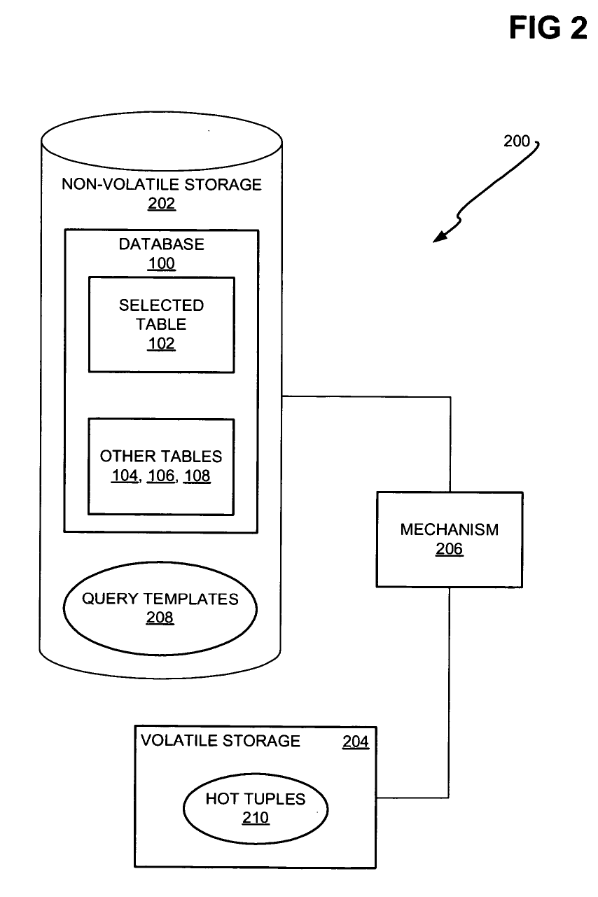

FIG. 2 shows a computerized system 200, according to an embodiment of the invention. The system 200 is depicted in FIG. 2 in relation to the database 100 of FIG. 1, but can be employed in relation to other databases, as can be appreciated by those of ordinary skill within the art. As can also be appreciated by those of ordinary skill within the art the system 200 can and typically does include other components, in addition to those shown in FIG. 2.

The non-volatile storage 202 may be one or more hard disk drives, or another type of non-volatile storage. By comparison, the volatile storage 204 may be a semiconductor memory, such as a dynamic random-access memory (DRAM), or another type of volatile storage. In general, the non-volatile storage 202 is slower than the volatile storage 204. That is, the volatile storage 204 is accessed more quickly than the non-volatile storage 202 is.

The non-volatile storage 202 stores the database 100 that has been described, and thus the selected table 102 of which hot tuples are detected, and the multiple and other tables 104, 106, and 108. The storage 202 also stores the query templates 208 that have been described, with each encompassing a number of queries. By comparison, the storage 204 stores the hot tuples 210 that have been detected within the selected table 102. It is noted that the hot tuples of the selected table 102 are not moved to the storage 204, but rather are copied, cached, and/or buffered as the hot tuples 210 within the storage 204. More generally, there are already existing techniques for placing or storing hot objects, such as hot tuples. The placement or storage of such hot tuples is thus to be construed as just one example of such hot tuple placement or storage.

The mechanism 206 may be implemented in hardware, software, or a combination of hardware and software, such as one or more computer programs or computer program parts executed by processors of the system 200. The mechanism 206 is operatively connected to the storages 202 and 204. The mechanism 206 detects the hot tuples within the selected table 102, as has been described, and stores the hot tuples as the hot tuples 210 within the volatile storage 204. Thus, when the database 100 is accessed, any tuples that are one of the hot tuples 210 are retrieved from the volatile storage 204, instead of from the non-volatile storage 202. In this way, input/output (I/O) performance of the database 100 is improved.

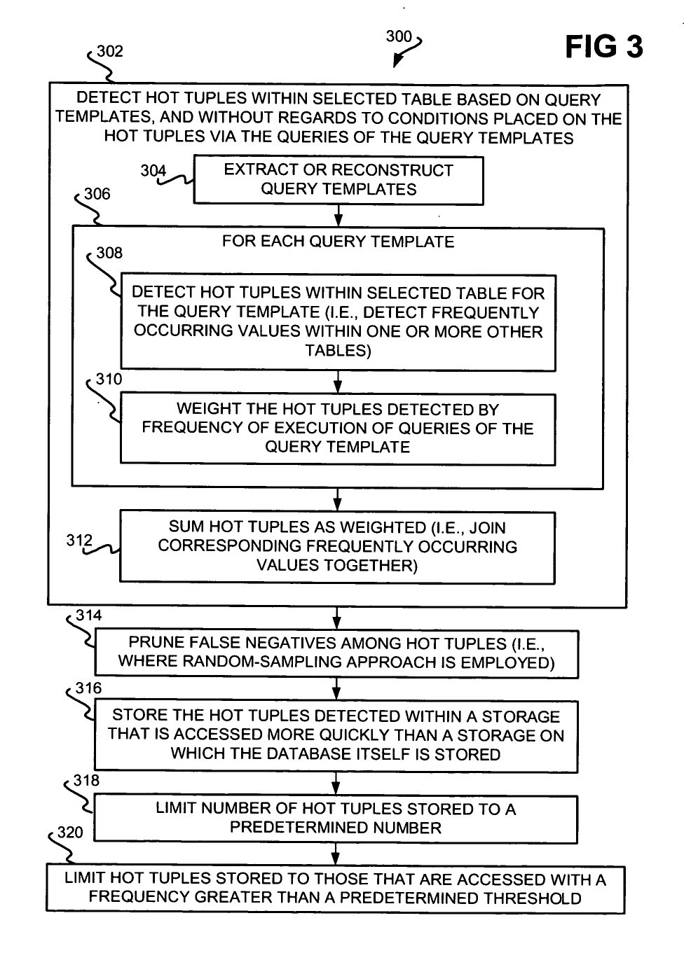

FIG. 3 shows a method 300, according to an embodiment of the invention. The method 300 is for improving I/O performance of a database, like the database 100, by detecting hot tuples within a selected table of the database, like the table 102 of the database 100, and storing the hot tuples within a storage, like the storage 204, which is accessed more quickly than the storage, like the storage 202, storing the database itself. The method 300 may be performed in one embodiment by the mechanism 206 of the computerized system 200 of FIG. 2, for instance.

The mechanism 206 detects the hot tuples within the selected table 102, based on the query templates 208 (302). As has been described, such detection can be without regards to bind variables in the select conditions that are placed on the tuples of the tables referencing selected table 102 via actual queries encompassed by the query templates 208. For instance, a query template may represent all the queries that join the table 102 with the table 104, where such a query may further specify that the tuples corresponding to employees having salaries over $80,000 be retrieved. This latter select condition is not considered when detecting hot tuples, and rather only the joining of the tables 102 and 104, as encompassed by the query template in question.

In varying embodiments, hot tuple detection may include performance of parts 302, 304, 306, 308, 310, and/or 312. First, the query templates 208 may be extracted or reconstructed (304). Reconstruction may be accomplished by employing a snapshot-monitoring program, which monitors performance of the database and thus retains statistics on the types of queries that are performed. From these statistics or other log information, query template construction can be achieved, as can be appreciated by those of ordinary skill within the art. In case of unavailability of the performance data, as may be stored in database performance logs, the query templates can also be received as an input from the user.

For each query template (306), the following is performed. First, the hot tuples within the selected table 102 for the query template are detected (308). That is, frequently occurring values within joining column(s) of one or more of the other and multiple tables 104, 106, and 108, for instance, are detected or determined. In one embodiment, the hot tuples detected are weighted by the frequency of execution of the queries within the query template in question (310). That is, the number of times each frequently occurring value occurs within a given other table, and which is also found in the selected table 102, is multiplied by the frequency of execution of the queries within the query template. Such frequencies of execution may also be determined from statistics or log information, which may be acquired by using a snapshot-monitoring program for the database. Examples of performance of parts 306, 308, and 310 have been essentially and effectively described above, in relation to the database 100 of FIG. 1.

Thereafter, the hot tuples as may have been weighted are summed together (312). That is, corresponding frequently occurring values, as may have been weighted, are joined together. Example performance of part 312 has also been essentially and effectively described above, in relation to the database 100 of FIG. 1. For instance, if a given tuple of the selected table 102 is referenced five times in the table 104, and six times in the table 106, then the hot tuple in question summed together appears within the tables 104 and 106 a total of eleven times, where weighting is not taken into account.

It is noted that the detection process of part 308 specifically and of part 302 more generally can utilize a random-sampling approach, such as a sequential random-sampling approach, to avoid having to examine all the tuples of the other tables 104, 106, and 108 in relation to the referencing of the tuples of the table 102. Rather, the tuples of the tables 104, 106, and 108 are randomly sampled to determine the hot tuples of the selected table 102. By virtue of such sampling, however, as can be appreciated by those of ordinary skill within the art, false negatives may result in the determination of the hot tuples of the table 102. Therefore, in accordance with known random-sampling techniques, for instance, such false negatives may be pruned, or removed, from the hot tuples of the selected table 102 (314).

It is noted that the detection of hot tuples within the selected table 102 can be considered in one embodiment as being classified in one of three different cases, as has been described in detail above, but which is summarized here for descriptive clarity. First, where there is just a single query template that contains a join condition on the table 102, the frequently occurring values within the joining column of each of any other table(s) joining with selected table 102 are determined. As can be appreciated by those of ordinary skill within the art, a joining column is a column of another table that joins with the selected table 102 in a given query template. The tuples of the table 102 corresponding to these frequently occurring values are then returned as the hot tuples. For instance, if the table 102 is joined with one other table, then the frequently occurring values are detected within the joining column of this other table, and the tuples of selected table 102 referenced by the frequently occurring values in the joining column of this other table are returned as the hot tuples for the selected table 102.

Second, there can be a number of query templates that each contain a join condition on the same column of the selected table 102. For each such query template, the frequently occurring values within a joining column of each of any other table(s) joining with the selected table 102 within the query template are determined, and the tuples of the table 102 corresponding to these frequently occurring values are determined, as well as corresponding frequencies of their occurrence. These hot tuples, as determined for each query template, are then merged together based on their frequencies of occurrence and frequencies of execution of the queries corresponding to the query templates, or based on another weighting factor(s) as has been described, to yield the final hot tuples for the selected table 102.

Third, there can be a number of query templates that some of which contain join conditions on different columns of the selected table 102. For each such query template, the frequently occurring values within the joining column of each of any other table(s) joining with the selected table 102 within the query template are determined, and the tuples of the table 102 corresponding to these frequently occurring values are determined, as well as corresponding frequencies of their occurrence. These hot tuples, as determined for each query template, are then, insofar as possible, merged together based on their frequencies of occurrence and frequencies of execution of queries corresponding to the query template, or based on another weighting factor(s) as has been described, to yield the final hot tuples.

In other words, then, embodiments of the invention determine hot tuples within a selected table by counting frequently occurring values in the joining column of each of one or more other tables joining with the selected table within one or more query templates. Furthermore, it has been stated herein that the frequently occurring values of the other tables are determined. As can be appreciated by those of ordinary skill within the art, however, this statement is shorthand for determining the frequently occurring values of the joining columns of these other tables.

The hot tuples, as may have been pruned, are then stored within a storage that is accessed more quickly than the storage on which the database 100 itself is stored (316). For instance, the mechanism 206 may store the hot tuples of the selected table 102, as the hot tuples 210, on the volatile storage 204, which is accessed more quickly than the storage 202 on which the database 100 is stored. It is noted that the storage 204 may have limited capacity to store the hot tuples of the selected table 102. Therefore, the number of hot tuples stored as the hot tuples 210 on the storage 204 may be limited in one or more of a number of different ways.

First, for instance, the number of the hot tuples 210 stored on the storage 204 may be limited to a predetermined number (318). This predetermined number may be determined via user input, such that it is user specified, or it may be determined without user input, via analysis of the computerized system 200 itself. For instance, a certain percentage of the amount of buffer memory available within the storage 204 may be employed, such that the number of hot tuples that can fit in this percentage of available memory is the predetermined number in question.

Second, the hot tuples 210 stored on the storage 204 may be limited to those that are accessed with a frequency greater than a predetermined threshold (320). This predetermined threshold may also be determined via user input, such that it is user specified, or it may be determined without user input, via analysis of the computerized system 200 itself. For instance, the predetermined threshold may be based on certain desired performance characteristics, such that a lower threshold is used when higher performance is needed, and vice-versa.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

What is claimed is:

1. A method comprising:
detecting a plurality of hot tuples within a selected table having a plurality of columns over which tuples are stored, the hot tuples included within the tuples stored in the selected table defined as the tuples that are frequently referenced by tuples of one or more other tables, wherein detection of the hot tuples is based on query templates of queries processed against a database including the selected table and the other tables referencing the selected table, the database stored on a non-volatile storage; and,
placing or storing the hot tuples detected to provide for quicker access thereof.

2. The method of claim 1, wherein the hot tuples are detected without regards to bind variables within select conditions placed thereon via the queries of the query templates.

3. The method of claim 1, wherein detecting the hot tuples within the selected table comprises employing a random-sampling approach.

4. The method of claim 1, wherein detecting the hot tuples within the selected table comprises employing a sequential random-sampling approach.

5. The method of claim 1, wherein detecting the hot tuples within the selected table comprises:
for each query template,
detecting the hot tuples within the selected table for the query template;
weighting the hot tuples detected within the selected table for the query templates by a frequency of execution of the queries of the query template; and,
summing the hot tuples detected within the selected table for the query templates as weighted.

6. The method of claim 1, wherein a single query template includes a join condition as to the selected table, such that detecting the hot tuples within the selected table comprises:
detecting frequently occurring values within a joining column of each of one or more other tables joining with the selected table within the single query template; and,
determining the hot tuples within the selected table as tuples within the selected table referenced by the frequently occurring values within the joining column of each of the other tables joining with the selected table within the single query template.

7. The method of claim 1, wherein a plurality of query templates each includes a join condition to a same column of the selected table, such that detecting the hot tuples within the selected table comprises:
for each query template, detecting frequently occurring values within a joining column of each of one or more other tables joining with the selected table within the query template;
for each query template, determining the hot tuples within the selected table as tuples within the selected table referenced by the frequently occurring values within the joining column of each of the other tables joining with the selected table within the query template; and,
merging the hot tuples within the selected table based on one or more weighting factors.

8. The method of claim 1, wherein a plurality of query templates include join conditions to different columns of the selected table, such that detecting the hot tuples within the selected table comprises:
for each query template, detecting frequently occurring values within a joining column of each of one or more other tables joining with the selected within the query template;
for each query template, determining the hot tuples within the selected table as tuples within the selected table referenced by the frequently occurring values within the joining column of each of the other tables joining with the selected table within the query template; and,
merging the hot tuples within the selected table based on one or more weighting factors, insofar as possible.

9. The method of claim 1, wherein detecting the hot tuples within the selected table comprises reconstructing the query templates from database performance logs.

10. The method of claim 1, wherein detecting the hot tuples within the selected table comprises determining the query templates with or without user input.

11. The method of claim 1, further comprising, for the hot tuples detected, limiting a number of the hot tuples stored within the storage to a predetermined number, such that the hot tuples stored within the storage are hottest of the hot tuples detected.

12. The method of claim 11, wherein the predetermined number is one of: user determined, and determined without user input via system analysis.

13. The method of claim 1, further comprising, for the hot tuples detected, limiting the hot tuples stored within the storage to the hot tuples that are accessed with a frequency greater than a predetermined threshold, such that the hot tuples stored within the storage are hottest of the hot tuples detected.

14. The method of claim 13, wherein the predetermined number is one of: user determined, and determined without user input via system analysis.

15. The method of claim 1, further comprising pruning false negatives within the hot tuples detected.

16. A computerized system comprising:
a non-volatile storage storing a database including a selected table having a plurality of columns over which tuples are stored and one or more other tables referencing the selected table;
a storage that is more quickly accessed than the non-volatile storage is, and that stores a plurality of hot tuples within the selected table, the hot tuples defined as the tuples of the selected table that are frequently referenced by tuples of the other tables; and,
a mechanism to detect the hot tuples within the selected table, based on query templates of queries processed against the database, and to store the hot tuples detected within the storage.

17. The computerized system of claim 16, wherein the hot tuples are detected without regards to select conditions placed thereon via the queries of the query templates.

18. The computerized system of claim 16, wherein the mechanism detects the hot tuples within the selected table by:
for each query template,
detecting the hot tuples within the selected table for the query template;
weighting the hot tuples detected within the selected table for the query template by a frequency of execution of the queries of the query template; and,
summing the hot tuples detected within the selected table for the query templates as weighted.

19. An article of manufacture comprising:
a tangible recordable data storage medium; and,
means in the medium for detecting a plurality of hot tuples within a selected table having a plurality of columns over which tuples are stored, based on query templates of queries processed against a database including the selected table and one or more other tables referencing the selected table, and for storing the hot tuples within a storage that is more quickly accessible than a non-volatile storage storing the database,
wherein the hot tuples are included within the tuples stored in the selected table and are defined as the tuples that are frequently referenced by tuples of the other tables, and
wherein the hot tuples are detected without regards to bind variables in select conditions placed thereon via the queries of the query templates.
